(19) United States
(12) Patent Application Publication
(10) Pub. No.: US 2017/0279700 A1
(43) Pub. Date: Sep. 28, 2017

(54) METHOD AND APPARATUS FOR TRANSMITTING DATA

(71) Applicants: Le Holdings(Beijing)Co., Ltd., Beijing (CN); Le Cloud Computing Co., Ltd., Beijing (CN)

(72) Inventor: Jun CAI, Beijing (CN)

(21) Appl. No.: 15/247,838

(22) Filed: Aug. 25, 2016

Related U.S. Application Data
(63) Continuation of application No. PCT/CN2016/088973, filed on Jul. 6, 2016.

(30) Foreign Application Priority Data
Mar. 25, 2016 (CN) 201610180447.0

(51) Int. Cl. H04L 12/26; H04L 12/721

(52) U.S. Cl. CPC H04L 43/0894; H04L 45/72; H04L 43/16; H04L 5/16

(57) ABSTRACT

Embodiments of the application provide a method and apparatus for transmitting data. In the solution of the application, the method and apparatus obtain at least one transmission link from a source address of data to be transmitted, to a destination address of the data to be transmitted, according to the source address and the destination address; select at least one of the transmission links; test for each selected transmission links a transmission rate of the transmission link over which data are transmitted respectively in a first transmission protocol and a second transmission protocol; and select the transmission protocol and the transmission link corresponding to the highest transmission rate to transmit the data to be transmitted. With the method according to the embodiments of the application, two transmission protocols can be supported to adapt to a complex network environment so as to improve the efficiency of data transmission. Moreover in the embodiments of the application, the transmission rate can be further monitored in real time while the data to be transmitted are being transmitted so that if the transmission rate is low, then the transmission protocol and/or the transmission link will be switched to thereby further improve the efficiency of data transmission.

### CROSS REFERENCE TO RELATED APPLICATIONS

This application is a continuation of International Application No. PCT/CN2016/088973, filed on Jul. 6, 2016, which is based upon and claims priority to Chinese Patent Application No. 201610180447.0, filed on Mar. 25, 2016, the entire contents of which are incorporated herein by reference.

### TECHNICAL FIELD

The present application relates to the field of communications, and particularly to a method and apparatus for transmitting data.

### BACKGROUND

Data transmission is an important function of a network. As the communication technologies are being developed and improved constantly, more and more data are transmitted from one node to another node over the network. Moreover the amount of data also comes to be growing, thus resulting in an increasing demand for the network.

Generally there are two data transmission protocols in the prior art, where one data transmission protocol is the Transmission Control Protocol (TCP), and the other data transmission protocol is the User Datagram Protocol (UDP).

In the prior art, a network device supports only one data protocol, and the inventors have identified during making the application that the existing data transmission solution is so simplex that a complex network environment can not be adapted to, thus degrading the efficiency of data transmission. For example, the TCP transmission protocol has been designed so that a high-bandwidth network may be so underutilized that the efficiency of transmission is typically less than 20% of the bandwidth, thus making it very difficult to obtain data in real time. This may increase a cost of deploying and leasing wideband, and also waste a significant bandwidth of the network. A bandwidth can be made full use of in the UDP transmission protocol; and since it is a non-connectivity stateless protocol, the reliability and security of data may not be highly guaranteed, and UDP transmission may be restrained in some network, thus making it impossible to exchange data.

In summary, there is a need of an innovative data transmission method so as to address the problem in the prior art of failing to adapt to a complex network environment in the simplex data transmission solution, thus degrading the efficiency of data transmission.

### SUMMARY

Embodiments of the application provide a method and apparatus for transmitting data so as to address the problem in the prior art of failing to adapt to a complex network environment in the simplex data transmission solution, thus degrading the efficiency of data transmission.

Particular technical solutions according to the embodiments of the application are as follows:

In an aspect, an embodiment of the application provides a method for transmitting data, the method including:

obtaining at least one transmission link from a source address of data to be transmitted, to a destination address of the data to be transmitted, according to the source address and the destination address;

selecting at least one of the transmission links;

testing for each selected transmission links a transmission rate of the transmission link over which data are transmitted respectively in a first transmission protocol and a second transmission; and

selecting the transmission protocol and the transmission link corresponding to the highest transmission rate to transmit the data to be transmitted.

In an aspect, an embodiment of the application provides an apparatus for transmitting data, the apparatus including:

a transmission link obtaining module configured to obtain at least one transmission link from a source address of data to be transmitted, to a destination address of the data to be transmitted, according to the source address and the destination address;

a transmission link selecting module configured to select at least one of the transmission links;

a transmission rate testing module configured to test for each selected transmission link a transmission rate of the transmission link over which data are transmitted respectively in a first transmission protocol and a second transmission; and

a first transmitting module configured to select the transmission protocol and the transmission link corresponding to the highest transmission rate to transmit the data to be transmitted.

An advantageous effect of the embodiments of the application lie in that in the embodiments of the application, the appropriate transmission link and transmission protocol are selected according to the transmission rates of the different transmission links in the different transmission protocols to transmit the data to be transmitted, so that the different transmission protocols can be supported to adapt to the network environment in which the different transmission protocols are applicable, to thereby improve the efficiency of data transmission.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is an exemplary flow chart of a method for transmitting data according to some embodiments of the application;

FIG. 2 is an exemplary flow chart of a method for transmitting data according to some embodiments of the application; and

FIG. 3 is a schematic structural diagram of an apparatus for transmitting data according to some embodiments of the application.

### DETAILED DESCRIPTION

In order to make the objects, technical solutions, and advantages of the embodiments of the application more apparent, the technical solutions according to the embodiments of the application will be described below clearly and fully with reference to the drawings in the embodiments of the application, and apparently the embodiments described below are only a part but not all of the embodiments of the application. Based upon the embodiments here of the application, all the other embodiments which can occur to those skilled in the art without any inventive effort shall fall into the scope of the application.

### First Embodiment

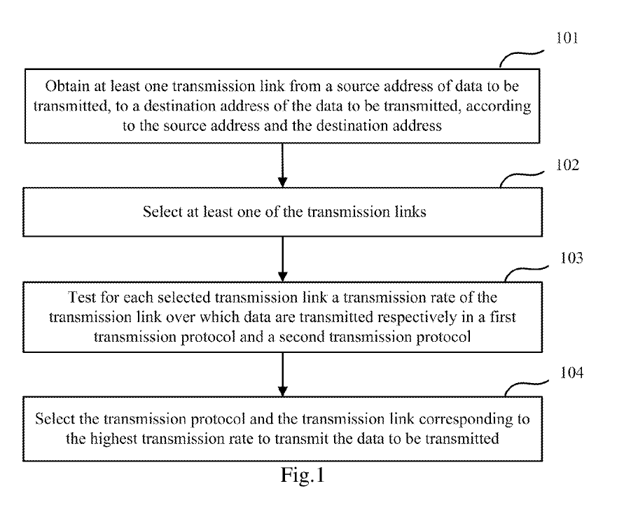

As illustrated in FIG. 1, there is a schematic flow chart of a method for transmitting data according to an embodiment of the application, where the method includes the following steps:

The step 101 is to obtain at least one transmission link from a source address of data to be transmitted, to a destination address of the data to be transmitted, according to the source address and the destination address.

The step 102 is to select at least one of the transmission links.

The step 103 is to test for each selected transmission link a transmission rate of the transmission link over which data are transmitted respectively in a first transmission protocol and a second transmission protocol.

Where the first transmission protocol and the second transmission protocol are different transmission protocols, for example, the first transmission protocol is the TCP, and the second transmission protocol is the UDP. Of course, in a particular implementation, other transmission protocols which can be applied as needed in reality will alternatively be applicable to the embodiment, so the embodiment of the application will not be limited thereto.

The step 104 is to select the transmission protocol and the transmission link corresponding to the highest transmission rate to transmit the data to be transmitted.

Thus in the embodiment of the application, the appropriate transmission link and transmission protocol can be selected according to the transmission rates of the transmission links respectively in the first transmission protocol and the second transmission protocol to thereby better adapt to a complex network environment. For example, if some link can not support the UDP, then the TCP will be applied for transmission to thereby ensure the efficiency of transmitting the data.

Here in an embodiment, in order to further improve the efficiency of transmission, the transmission rates of the respective transmission links respectively in the respective transmission protocols can be recorded in advance so that the data can be transmitted next time by selecting the reasonable transmission link and transmission protocol according to the recorded information to transmit the data without testing the transmission rates before the data are transmitted each time. Particularly before at least one of the transmission rates is selected, the method in an embodiment of the application can further include the following steps:

The step A1 is to search, according to a three-dimension correspondence relationship between a transmission link, a transmission protocol, and a transmission rate, for at least one transmission link from the source address to the destination address.

For example the three-dimension correspondence relationship can be as depicted in Table 1. It shall be noted that Table 1 is merely intended to illustrate but not limit the embodiment of the application. The three-dimension correspondence relationship can be stored in a form determined as needed in reality, so the embodiment of the application will not be limited thereto.

TABLE 1
Three-dimension correspondence relationship

| Transmission link | Transmission protocol | Transmission rate |
|---|---|---|
| L1 | TCP | 10 |
| | UDP | 20 |
| . . . | . . . | . . . |
| Ln | TCP | 0 |
| | UDP | 30 |

Here in an embodiment, the transmission rate can be represented as a real transmission rate, or can be represented as a level corresponding to the transmission rate, for example, the level of the transmission rate higher than a first transmission rate is normal, the level of the transmission rate lower than the first transmission rate and higher than a second transmission rate is slow, and the level of the transmission rate lower than the second transmission rate is a jam, where the first transmission rate is higher than the second transmission rate.

The step A2 is to perform the step 102 if no transmission link is found.

The step A3 is, if at least one transmission link is found, to search the at least one transmission link from the source address to the destination address for a transmission link with a transmission rate above a transmission rate threshold according to the three-dimension correspondence relationship.

The step A4 is, if there is a transmission link with its transmission rate above the transmission rate threshold, to select the transmission rate above the transmission rate threshold, and the transmission link and the transmission protocol corresponding thereto to transmit the data to be transmitted.

Here in an embodiment, if there is no transmission link above the transmission rate threshold, then the flow will go back to the step 102, or select directly the transmission link with the highest transmission rate to transmit the data to be transmitted.

Here in an embodiment, in order to ensure information integrity of the three-dimension correspondence relationship so that the transmission link and the transmission protocol can be determined according to the three-dimension correspondence relationship, after the step 103 (that is, for each selected transmission link, the transmission rate of the transmission link over which data are transmitted respectively over the first transmission protocol and the second transmission protocol is tested) in the embodiment of the application, the method can further includes: adding the tested respective transmission links, and the transmission protocols and the transmission rates corresponding thereto to the three-dimension correspondence relationship, so that the three-dimension correspondence relationship can be supplemented in a timely manner to thereby ensure information integrity of the three-dimension correspondence relationship.

Here in an embodiment, in order to ensure the three-dimension correspondence relationship to be time-effective, and the data thereof to be accurate, the data in the three-dimension correspondence relationship can be further updated in the embodiment of the application particularly in the following steps:

The step B1 is to determine whether a current load is less than a preset load;

The step B2 is, if so, to select a correspondence relationship with a transmission rate less than a lower transmission rate limit from the three-dimension correspondence relationship, to retest the transmission rate of the transmission link in the selected correspondence relationship over which data are transmitted in the transmission protocol in the correspondence relationship, and to update the transmission rate in the correspondence relationship with a result of the retest.

Thus in the embodiments of the application, the three-dimension correspondence relationship can be updated in a timely manner while supporting various businesses (that is, the current load is less than the preset load) to thereby make full use of device processing resources while ensuring the accuracy of the data in the three-dimension correspondence relationship.

Here in an embodiment, in order to further improve the efficiency of data transmission while ensuring stable transmission of the data, the data to be transmitted can be further transmitted in the embodiment of the application in the following steps:

The step C1 is to monitor the transmission rate of the data to be transmitted; and to determine whether the transmission rate is lower than a limited transmission rate.

The step C2 is, if the transmission rate is lower than the limited transmission rate, to search the at least one transmission link from the source address to the destination address, according to the three-dimension correspondence relationship.

Thus equivalently the transmission scheme is altered in the step C2 so that the altered transmission scheme may fall into one of the following three instances:

1. Only the transmission protocol is altered, where for example, if the data to be transmitted are transmitted over the transmission link 1 in the TCP transmission protocol, then the transmission scheme will be altered so that the data to be transmitted are transmitted over the transmission link 1 in the UDP transmission protocol;

2. Only the transmission link is altered, where for example, if the data to be transmitted are transmitted over the transmission link 1 in the TCP transmission protocol, then the transmission scheme will be altered so that the data to be transmitted are transmitted over the transmission link 2 in the TCP transmission protocol; and

3. Both the transmission protocol and the transmission link altered, where for example, if the data to be transmitted are transmitted over the transmission link 1 in the TCP transmission protocol, then the transmission scheme will be altered so that the data to be transmitted are transmitted over the transmission link 2 in the UDP transmission protocol

Thus if the transmission rate of the data to be transmitted is lower than the limited transmission rate, then it will indicate that the data are being transmitted so slowly that it may be difficult to transmit the data to the destination address as soon as possible. In view of this, in order to improve the efficiency of data transmission, the transmission scheme can be altered so that the data can be transmitted to the destination address more quickly; and the transmission rate of the data to be transmitted will not vary significantly, or the data to be transmitted will not be interrupted, while be transmitted; and the data to be transmitted will be transmitted stably.

Here in an embodiment, in order to prevent an illegal user from falsifying the data so as to guarantee the security of the data, the data to be transmitted includes integrity check information of the data. In view of this, in an embodiment, it can be determined from the integrity check information of the data whether the data are integral.

If it is determined from the integrity check information of the data that the data are not integral, then a message requesting for retransmission of the data to a client.

Here in an embodiment, in order to guarantee the security of the data being transmitted, the data to be transmitted can be further transmitted in an embodiment of the application in the following steps:

The step D1 is to receive an identity authentication information of a user requesting for transmitting the data to be transmitted, transmitted by a client.

The step D2 is to determine from the identity authentication information whether the user is a legal user.

The step D3 is, if the user is a legal user, to transmit the data to be transmitted.

Thus the user can be authenticated for the identity thereof using the identity authentication information to thereby ensure that the data to be transmitted are transmitted by the legal user, and only the legal user can be allowed to transmit data to thereby guarantee the security of data transmitted over the network.

Here in an embodiment, in order to enable the user transmitting the data to be transmitted to select a transmission scheme suitable for himself or herself, before the at least one transmission link from the source address to the destination address is searched, using the three-dimension correspondence relationship, for a transmission link with a transmission rate above the transmission rate threshold in the step A3, the method in the embodiment of the application can further include the following steps:

The step E1 is to transmit transmission links among the at least one transmission link from the source address to the destination address that are present in the three-dimension correspondence relationship, and the transmission rates corresponding thereto to the client requesting for transmission of the data to be transmitted, and to display the transmission links on the client.

Thus the user can select a transmission scheme suitable for himself or herself according to the transmission links, the transmission protocols, and the transmission rates displayed on the client. Of course, the client can provide two modes in which a transmission scheme is selected manually and in which a transmission scheme is selected automatically. Thus the step A3 in the embodiment of the application is equivalent to the mode in which a transmission scheme is selected automatically, and the step A3 can be performed further to the step E2.

The step E2 is to determine that information transmitted by the client to request for automatic selection of a transmission link is received.

Thus in the embodiments of the application, the transmission link and the transmission protocol suitable for the user can be selected as needed for the user in reality (when the user decides to select automatically a transmission link) to thereby improve the experience of the user.

Here in an embodiment, a transmission history record of the at least one transmission link from the source address to the destination address can be transmitted to the client for storage so that the user can view the history record, and even select a transmission scheme (i.e., a transmission link and a transmission protocol) by referring to the history record. The history record can include the amounts of transmitted data, the times when the data were transmitted, the transmission links, and the transmission rates.

Here in an embodiment, if there are two sets of data to be transmitted, then the client will further provide a function for the user to specify a order in which the at least two sets of data to be transmitted are transmitted, and/or time when the at least two sets of data to be transmitted are transmitted, so the data to be transmitted can be transmitted in the embodiment of the application particularly in the following steps:

The step F1 is to receive an order in which the at least two sets of data to be transmitted are transmitted, and/or time when the at least one set of data to be transmitted is transmitted respectively, transmitted by the client.

The step F2 is to transmit the respective sets of data to be transmitted, in the order in which the at least two sets of data to be transmitted are transmitted, and/or the time when the at least one set of data to be transmitted is transmitted respectively.

For example, the data to be transmitted include data A1 and data A2, where if firstly the data A1 are to be transmitted at 15:00, and then the data A2 are to be transmitted at 15:20, then the data A1 will be transmitted at 15:00, and the data A2 will be transmitted at 15:20.

In summary in the embodiments of the application, the appropriate transmission link and transmission protocol are selected according to the transmission rates of the different transmission links in the different transmission protocols to transmit the data to be transmitted, so that the different transmission protocols can be supported to adapt to the network environment in which the different transmission protocols are applicable, to thereby improve the efficiency of data transmission.

Moreover the appropriate transmission link and transmission protocol can be selected rapidly and accurately using the three-dimension correspondence relationship to transmit the data to be transmitted, to thereby further improve the transmission rate of the data.

Moreover in the embodiments of the application, the transmission rate of the data to be transmitted can be further monitored in real time while the data to be transmitted are being transmitted, and if the transmission rate is low, then the transmission scheme will be altered in a timely manner to thereby guarantee the stability of data transmission.

### Second Embodiment

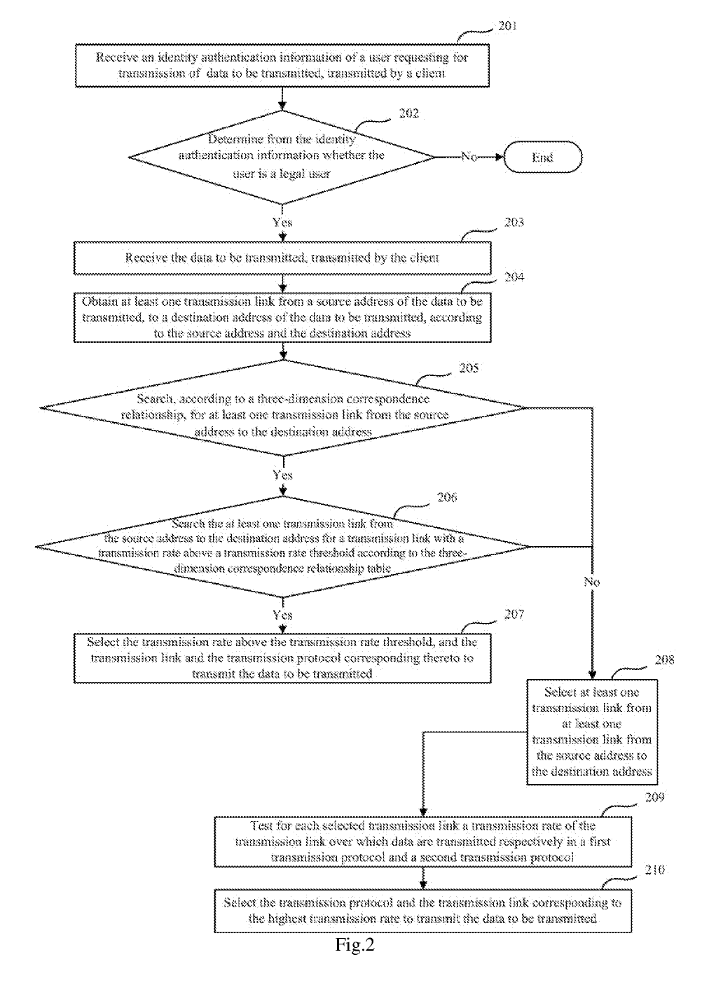

In order to further understand the application, a method for transmitting data according to an embodiment of the application will be further described with reference to FIG. 2, where the method can include the following steps:

The step 201 is to receive the identity authentication information of a user requesting for transmission of data to be transmitted, transmitted by a client.

The step 202 is to determine from the identity authentication information whether the user is a legal user, and if so, then the flow will proceed to the step 203; otherwise, the flow will end.

The step 203 is to receive the data to be transmitted, transmitted by the client.

The step 204 is to obtain at least one transmission link from a source address of the data to be transmitted to a destination address of the data to be transmitted, according to the source address and the destination address.

The step 205 is to search, according to a three-dimension correspondence relationship between a transmission link, a transmission protocol, and a transmission rate, for at least one transmission link from the source address to the destination address, and if there is at least one transmission link from the source address to the destination address, then the flow will proceed to the step 206; otherwise, the flow will proceed to the step 208.

The step 206 is to search the at least one transmission link from the source address to the destination address for a transmission link with a transmission rate above a transmission rate threshold according to the three-dimension correspondence relationship, and if there is a transmission link with a transmission rate above a transmission rate threshold, then the flow will proceed to the step 207; otherwise, the flow will proceed to the step 208.

The step 207 is to select the transmission rate above the transmission rate threshold, and the transmission link and the transmission protocol corresponding thereto to transmit the data to be transmitted.

The step 208 is to select at least one transmission link from the at least one of transmission link from the source address to the destination address.

The step 209 is to test for each selected transmission link a transmission rate of the transmission link over which data are transmitted respectively in a first transmission protocol and a second transmission protocol.

The step 210 is to select the transmission protocol and the transmission link corresponding to the highest transmission rate to transmit the data to be transmitted.

Of course, the transmission rate of the data to be transmitted will be further monitored while the data to be transmitted are being transmitted so that an appropriate transmission scheme will be selected, and this has been described in the first embodiment, so a repeated description thereof will be omitted here.

Here the technical solution according to the embodiment of the application is particularly applicable to a large amount of data to be transmitted (that is, the amount of data to be transmitted is above an amount of data threshold), and even particularly to data to be transmitted between servers separate from each other.

### Third Embodiment

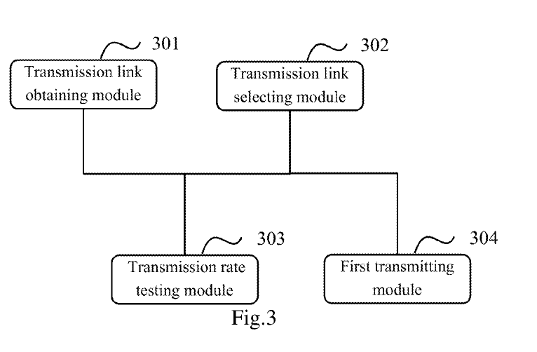

Based upon the same inventive concept, an embodiment of the application further provides an apparatus for transmitting data as illustrated in FIG. 3, where the apparatus includes:

A transmission link obtaining module 301 is configured to obtain at least one transmission link from a source address of data to be transmitted, to a destination address of the data to be transmitted, according to the source address and the destination address;

A transmission link selecting module 302 is configured to select at least one of the transmission links;

A transmission rate testing module 303 is configured to test for each selected transmission link a transmission rate of the transmission link over which data are transmitted respectively in a first transmission protocol and a second transmission protocol; and

A first transmitting module 304 is configured to select the transmission protocol and the transmission link corresponding to the highest transmission rate to transmit the data to be transmitted.

Here in an embodiment, the apparatus further includes:

A transmission link searching module is configured to search, according to a three-dimension correspondence relationship between a transmission link, a transmission protocol, and a transmission rate, for at least one transmission link from the source address to the destination address;

A selection triggering module is configured, if a result of searching by the transmission link searching module is negative, to trigger the transmission link selecting module to select at least one of the transmission links;

A transmission link picking module is configured, if the result of searching by the transmission link searching module is positive, to search the at least one transmission link from the source address to the destination address for a transmission link with a transmission rate above a transmission rate threshold according the three-dimension correspondence relationship; and

A second transmitting module is configured, if the transmission link picking module determines that there is a transmission link with its transmission rate above the transmission rate threshold, to select the transmission rate above the transmission rate threshold, and the transmission link and the transmission protocol corresponding thereto to transmit the data to be transmitted.

Here in an embodiment, the apparatus further includes:

A correspondence relationship adding module is configured, after the transmission link testing module tests for each selected transmission link the transmission rate of the transmission link over which data are transmitted respectively in the first transmission rate and the second transmission protocol, to add the tested respective transmission links, and the transmission protocols and the transmission rates corresponding thereto to the three-dimension correspondence relationship.

Here in an embodiment, the apparatus further includes:

A load determining module is configured to determine whether a current load is less than a preset load; and

A correspondence relationship updating module is configured, if a result of the determination by the loading determining module is positive, to select a correspondence relationship with a transmission rate less than a lower transmission rate limit from the three-dimension correspondence relationship, to retest the transmission rate of the transmission link in the selected correspondence relationship over which data are transmitted in the transmission protocol in the correspondence relationship, and to update the transmission rate in the correspondence relationship with a result of the retest.

Here in an embodiment, the apparatus further includes:

A monitoring module is configured to monitor the transmission rate of the data to be transmitted while the first transmitting module or the second transmitting module are transmitting the data to be transmitted, and to determine whether the transmission rate is less than a limited transmission rate; and

A transmission scheme altering module is configured to trigger the transmission link picking module to search the at least one transmission link from the source address to the destination address for a transmission link with a transmission rate above the transmission rate threshold according to the three-dimension correspondence relationship.

Here in an embodiment, the data to be transmitted include integrity check information of the data, and the apparatus further includes:

An integrity determining module configured to determine from the integrity check information of the data that the data to be transmitted are intact.

Here in an embodiment, the apparatus further includes:

An identity authentication information obtaining module is configured to obtain an identity authentication information of a user requesting for transmission of the data to be transmitted;

A legal user determining module is configured to determine from the identity authentication information whether the user is a legal user; and

A transmission triggering module is configured, if the user is a legal user, to trigger the first transmitting module or the second transmitting module to transmit the data to be transmitted.

Here in an embodiment, the apparatus further includes:

An information transmitting module is configured to transmit transmission links among the at least one transmission link from the source address to the destination address that are present in the three-dimension correspondence relationship, and the transmission rates corresponding thereto to a client requesting for transmission of the data to be transmitted, so that the transmission links are displayed on the client, before the transmission link picking module searches the at least one transmission link from the source address to the destination address for a transmission link with a transmission rate above the transmission rate threshold according to the three-dimension correspondence relationship; and

An automatic selection determining module is configured to determine that information transmitted by the client to request for automatic selection of a transmission link is received.

In summary in the embodiments of the application, the appropriate transmission link and transmission protocol are selected according to the transmission rates of the different transmission links in the different transmission protocols to transmit the data to be transmitted, so that the different transmission protocols can be supported to adapt to the network environment in which the different transmission protocols are applicable, to thereby improve the efficiency of data transmission.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the application. This can be understood and practiced by those ordinarily skilled in the art without any inventive effort.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the application; and although the application has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the application as claimed.

What is claimed is:

1. A method for transmitting data, the method comprising:
obtaining at least one transmission link from a source address of data to be transmitted, to a destination address of the data to be transmitted, according to the source address and the destination address;
selecting at least one of the transmission links;
testing for each selected transmission links a transmission rate of the transmission link over which data are transmitted respectively in a first transmission protocol and a second transmission protocol; and
selecting the transmission protocol and the transmission link corresponding to the highest transmission rate to transmit the data to be transmitted.

2. The method according to claim 1, wherein the method further comprises:
searching, according to a three-dimension correspondence relationship between a transmission link, a transmission protocol, and a transmission rate, for at least one transmission link from the source address to the destination address;
if no transmission link is found, then selecting at least one of the transmission links;
if at least one transmission link is found, searching the at least one transmission link from the source address to the destination address for a transmission link with a transmission rate above a transmission rate threshold according to the three-dimension correspondence relationship; and
if there is a transmission link with its transmission rate above the transmission rate threshold, then selecting the transmission rate above the transmission rate threshold, and the transmission link and the transmission protocol corresponding thereto to transmit the data to be transmitted.

3. The method according to claim 2, wherein after testing for each selected transmission link the transmission rate of the transmission link over which data are transmitted respectively in the first transmission rate and the second transmission protocol, the method further comprises:
adding the tested respective transmission links, and the transmission protocols and the transmission rates corresponding thereto to the three-dimension correspondence relationship.

4. The method according to claim 2, wherein the method further comprises:
determining whether a current load is less than a preset load; and
if so, then selecting a correspondence relationship with a transmission rate less than a lower transmission rate limit from the three-dimension correspondence relationship, retesting the transmission rate of the transmission link in the selected correspondence relationship over which data are transmitted in the transmission protocol in the correspondence relationship, and updating the transmission rate in the correspondence relationship with a result of the retest.

5. The method according to claim 2, wherein while transmitting the data to be transmitted, the method further comprises:
monitoring the transmission rate of the data to be transmitted, and determining whether the transmission rate is less than a limited transmission rate; and
if so, then searching the at least one transmission link from the source address to the destination address for a transmission link with a transmission rate above the transmission rate threshold according to the three-dimension correspondence relationship.

6. The method according to claim 1, wherein the data to be transmitted comprise integrity check information of the data, and the method further comprises:
determining from the integrity check information of the data that the data to be transmitted are intact.

7. The method according to claim 1, wherein the method further comprises:
receiving an identity authentication information of a user requesting for transmission of the data to be transmitted, transmitted by a client;
determining from the identity authentication information whether the user is a legal user; and
if the user is a legal user, transmitting the data to be transmitted.

8. The method according to claim 2, wherein before searching the at least one transmission link from the source address to the destination address for a transmission link with a transmission rate above the transmission rate threshold according to the three-dimension correspondence relationship, the method further comprises:
transmitting transmission links among the at least one transmission link from the source address to the destination address that are present in the three-dimension correspondence relationship, and the transmission rates corresponding thereto to a client requesting for transmission of the data to be transmitted, and displaying the transmission links on the client; and
determining that information transmitted by the client to request for automatic selection of a transmission link is received.

9. An apparatus for transmitting data, the apparatus comprising:
at least one processor; and
a memory communicably connected with the at least one processor for storing instructions executable by the at least one processor, wherein execution of the instructions by the at least one processor causes the at least one processor to:
obtain at least one transmission link from a source address of data to be transmitted, to a destination address of the data to be transmitted, according to the source address and the destination address;
select at least one of the transmission links;
test for each selected transmission link a transmission rate of the transmission link over which data are transmitted respectively in a first transmission protocol and a second transmission protocol; and
select the transmission protocol and the transmission link corresponding to the highest transmission rate to transmit the data to be transmitted.

10. The apparatus according to claim 9, wherein the execution of the instructions by the at least one processor further causes the at least one processor to:
search, according to a three-dimension correspondence relationship between a transmission link, a transmission protocol, and a transmission rate, for at least one transmission link from the source address to the destination address;
if no transmission link is found, select at least one of the transmission links;
if at least one transmission link is found, search the at least one transmission link from the source address to the destination address for a transmission link with a transmission rate above a transmission rate threshold according to the three-dimension correspondence relationship; and
if there is a transmission link with its transmission rate above the transmission rate threshold, select the transmission rate above the transmission rate threshold, and the transmission link and the transmission protocol corresponding thereto to transmit the data to be transmitted.

11. The apparatus according to claim 10, wherein the execution of the instructions by the at least one processor further causes the at least one processor to:
after testing for each selected transmission link the transmission rate of the transmission link over which data are transmitted respectively in the first transmission rate and the second transmission protocol, add the tested respective transmission links, and the transmission protocols and the transmission rates corresponding thereto to the three-dimension correspondence relationship.

12. The apparatus according to claim 10, wherein the execution of the instructions by the at least one processor further causes the at least one processor to:
determine whether a current load is less than a preset load; and
if so, select a correspondence relationship with a transmission rate less than a lower transmission rate limit from the three-dimension correspondence relationship, retest the transmission rate of the transmission link in the selected correspondence relationship over which data are transmitted in the transmission protocol in the correspondence relationship, and update the transmission rate in the correspondence relationship with a result of the retest.

13. The apparatus according to claim 10, wherein the execution of the instructions by the at least one processor further causes the at least one processor to:
monitor the transmission rate of the data to be transmitted while the data to be transmitted are being transmitted, and determine whether the transmission rate is less than a limited transmission rate; and
if the transmission rate is less than the limited transmission rate, search the at least one transmission link from the source address to the destination address for a transmission link with a transmission rate above the transmission rate threshold according to the three-dimension correspondence relationship.

14. The apparatus according to claim 9, wherein the data to be transmitted comprise integrity check information of the data, and the execution of the instructions by the at least one processor further causes the at least one processor to:
determine from the integrity check information of the data that the data to be transmitted are intact.

15. The apparatus according to claim 9, wherein the execution of the instructions by the at least one processor further causes the at least one processor to:
obtain an identity authentication information of a user requesting for transmission of the data to be transmitted;
determine from the identity authentication information whether the user is a legal user; and
if the user is a legal user, transmit the data to be transmitted.

16. The apparatus according to claim 10, wherein the execution of the instructions by the at least one processor further causes the at least one processor to:
transmit transmission links among the at least one transmission link from the source address to the destination address that are present in the three-dimension correspondence relationship, and the transmission rates corresponding thereto to a client requesting for transmission of the data to be transmitted, so that the transmission links are displayed on the client, before searching the at least one transmission link from the source address to the destination address for a transmission link with a transmission rate above the transmission rate threshold according to the three-dimension correspondence relationship; and
determine that information transmitted by the client to request for automatic selection of a transmission link is received.

17. A non-transitory computer-readable storage medium storing executable instructions that, when executed by an electronic device with a touch-sensitive display, cause the electronic device to:
obtain at least one transmission link from a source address of data to be transmitted, to a destination address of the data to be transmitted, according to the source address and the destination address;
select at least one of the transmission links;
test for each selected transmission link a transmission rate of the transmission link over which data are transmitted respectively in a first transmission protocol and a second transmission protocol; and
select the transmission protocol and the transmission link corresponding to the highest transmission rate to transmit the data to be transmitted.
